(19) United States
(12) Patent Application Publication
(10) Pub. No.: US 2009/0108132 A1
(43) Pub. Date: Apr. 30, 2009

(54) Seating Apparatus

(75) Inventor: Roland Guttropf, Blaufelden (DE)

Correspondence Address: POSZ LAW GROUP, PLC, 12040 SOUTH LAKES DRIVE, SUITE 101, RESTON, VA, 20191, US

(73) Assignee: RECARO Aircraft Seating GmbH & Co. KG, 74523 Schwabisch hall (DE)

(21) Appl. No.: 12/225,586

(22) PCT Filed: Jan. 30, 2007
(86) PCT No.: PCT/EP2007/000769

§ 371 Date: Oct. 28, 2008

(30) Foreign Application Priority Data
Mar. 31, 2006 (DE) 10 2006 015 515.7

(51) Int. Cl. B64D 11/06

(52) U.S. Cl. 244/122 R; 297/452.18

(57) ABSTRACT

A seating apparatus, in particular, an aircraft seating apparatus, includes a seating component (10) and at least one fastener (14). The fastener (14) has at least one latch (16, 18, 20, 22), which is adapted to fix the seating component (10) to a corresponding support component (50, 52).

### BACKGROUND OF THE INVENTION

The invention is based on a seating apparatus, in particular, an aircraft seating apparatus, with at least one seat component and a fastening unit for fastening to the seat component.

A seating apparatus with a seat component formed by a seat base and with a fastening unit for fastening the seat component to supporting tubes is already known. The fastening unit has fastening means which are formed by hose clamps and by means of which the seat component is fastened to the supporting tubes.

### SUMMARY OF THE INVENTION

The invention is based in particular on the problem of improving the fittability and removability.

The invention is based on a seating apparatus, in particular an aircraft seating apparatus, with at least one seat component and a fastening unit for fastening the seat component.

It is proposed that the fastening unit has at least one fastening means with at least one latching means which is provided for fastening the seat component, thus making it possible to achieve particularly simple fitting and removal which can be carried out rapidly and without tools. In this case, “provided” is to be understood in particular as meaning specially equipped and/or designed. A “latching means” is to be understood in particular as meaning a means which is provided in order to be deflected counter to an elastic tensioning force in order then subsequently, driven by the elastic tensioning force, to be moved into its latching position. In this case, the elastic tensioning force can be formed by an additional spring element, and/or can advantageously be implemented integrally with a latching arm and/or latching hook. Furthermore, a seat component is to be understood as meaning in particular a main component of a seat, such as a back rest, a leg rest and/or, particularly advantageously, a seat base.

In a further refinement of the invention, it is proposed that, in the fitted state, the fastening means is fastened to the seat component by means of the latching means, thus enabling the fastening means and the seat component to each be particularly advantageously coordinated with respect to their material with different requirements. Furthermore, a flexible arrangement of the fastening means on the seat component can be achieved. However, it is also conceivable for the fastening means together with the latching means to be at least partially integrally formed on the seat component, in particular in a multi-component process as well, thus enabling additional components, outlay on fitting and costs to be saved.

Furthermore, it is proposed that at least one latching means of the fastening means is provided in order to produce a latching connection between the fastening means and a corresponding component, as a result of which, in turn, the corresponding component and the fastening component can be configured, largely independently, in particular with regard to the choice of material, to different requirements. However, it would also be conceivable here for the fastening means to be at least partially integrally formed, such as in particular by a multi-component process, on a corresponding component which is formed in particular by a support component for absorbing supporting forces of the seat component.

The fastening means may be produced from various materials appearing expedient to a person skilled in the art, such as, in particular, from metal, a carbon fiber and/or, particularly advantageously, from a plastic, as a result of which said fastening means can be particularly light, cost-effective and also realized with a desired tensioning force in a structurally simple manner.

In a further refinement of the invention, it is proposed that the seating apparatus comprises a fastening unit for fastening an upholstery unit, the fastening unit of the seat component requiring a removal force in at least one main removal direction of the seat component which is at least 20%, preferably at least 40% and particularly preferably at least 50% greater than a required removal force in at least one main removal direction of the fastening unit of the upholstery unit, thus making it possible to reliably prevent the fastening unit for fastening the seat component to be undesirably detached during removal of the upholstery unit. In particular, the latching means is correspondingly designed for this purpose, to be precise in particular with regard to its shape, material thickness and/or type of material. In this case, a “main removal direction” is to be understood in particular to mean a predetermined removal direction, for example a removal direction predetermined by operating instructions, and/or a removal direction used primarily by an operator, with the main removal direction of the seat component in particular having a fixed orientation relative to the seat component.

Furthermore, an undesirable detachment can be advantageously avoided by the fastening unit having at least two fastening means which, in the fitted state, have differing main removal directions, i.e. in particular main removal directions which enclose an angle not equal to zero such that, in particular, a composite removal movement results, such as, in particular, a removal movement with a plurality of translatory movements in different directions and/or with at least one translatory movement and a pivoting movement and/or at least two pivoting movements about differing pivot axes.

If the fastening unit has at least two structurally identical fastening means, the multiplicity of parts and costs can be reduced, and erroneous fittings due to confusing differing fastening means can be prevented.

If the fastening means has at least two latching arms forming a C-shaped receiving region, an advantageous support, in particular on supporting tubes, can be achieved.

Furthermore, it is proposed that the fastening means has at least one barb-shaped latching arm, as a result of which a secure support can be achieved in a structurally simple manner.

If the seat component has at least one latching recess, the seat component can be realized in a structurally simple and cost-effective manner, in particular without latching arms. However, it is conceivable also to integrally form latching arms on the seat component and/or to fasten them thereto.

In a further refinement of the invention, it is proposed that the seating arrangement has at least one means which, at least in the fitted state, is arranged on the fastening means and has a higher coefficient of friction, in particular coefficient of static friction, than a basic body of the fastening means, as a result of which undesirable slipping and vibration noises can be avoided. In this case, the means with the higher coefficient of friction can be formed by a component which is to be additionally fitted, or it can be integrally formed on the fastening means, for example in a multi-component injection molding process. In addition, it is conceivable to provide a corresponding component, in particular a supporting tube, with a corresponding means.

Furthermore, it is proposed that the seating apparatus has at least one securing means which is provided in order to retain at least one latching means in its latching position. The securing means is preferably formed by a component which is separate from the latching means, but may also in turn be integrally formed on the latching means and/or on the seat component, and is connected to said latching means and/or said seat component, for example, via a film hinge, as a result of which said securing means could be retained captively on the fastening means or on the seat component. By means of a corresponding securing means, an undesirable detachment of a latching connection can be reliably avoided, to be precise in particular if the securing means itself has at least one latching means via which the securing means in turn can be secured in its securing position.

The solution according to the invention is suitable for all seats appearing expedient to a person skilled in the art, such as for seats for coaches, ferries, halls, convention halls, but advantageously for vehicle seats and particularly advantageously for aircraft seats.

### BRIEF DESCRIPTION OF THE DRAWINGS

Further advantages emerge from the description below of the drawing. The drawing illustrates an exemplary embodiment of the invention. The drawing, the description and the claims contain numerous features in combination. A person skilled in the art will expediently also consider the features individually and put them together to form meaningful further combinations.

In the drawing:

FIG. 1 shows an aircraft seating apparatus according to the invention in a view obliquely from below,

FIG. 2 shows a cross section through the aircraft seating apparatus according to FIG. 1 in a state fitted on two supporting tubes,

FIG. 3 shows a seat component of the aircraft seating apparatus obliquely from above,

FIG. 4 shows a fastening means of a fastening unit of the aircraft seating apparatus from FIG. 1 obliquely from the side,

FIG. 5 shows the fastening means from FIG. 4 with a securing means in a side view, and

FIG. 6 shows an enlarged detail from FIG. 5 after the securing means is fitted.

### DETAILED DESCRIPTION OF THE PREFERRED EMBODIMENTS

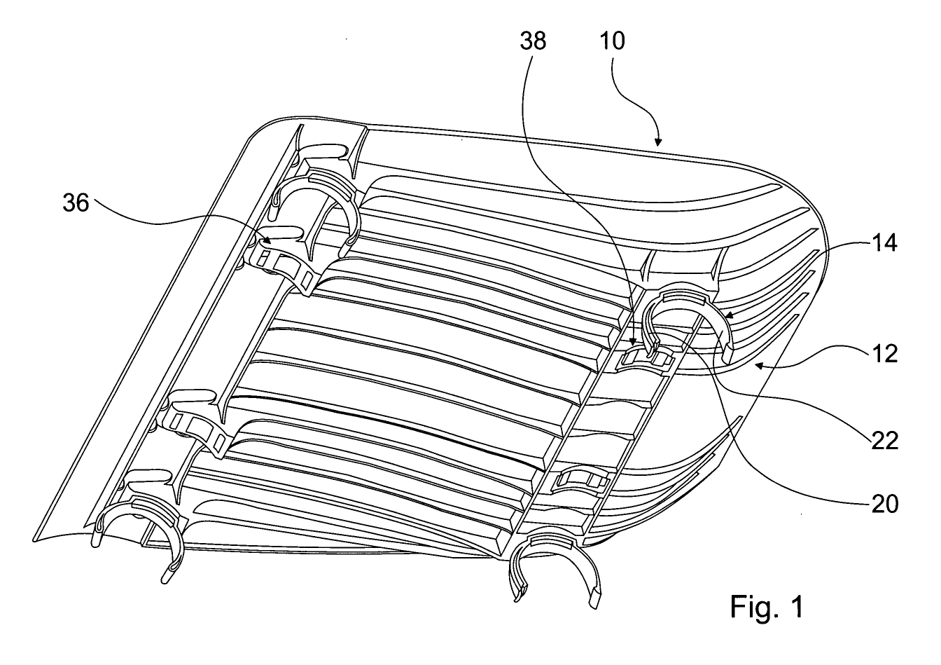

FIG. 1 shows an aircraft seating apparatus according to the invention in a view obliquely from below with a seat component 10 formed by a seat base and a fastening unit 12 for fastening the seat component 10. The fastening unit 12 comprises four structurally identical fastening means 14 which each have four latching means 16, 18, 20, 22 which are provided in order to fasten the seat component 10.

In the fitted state, the fastening means 14 is fastened in latching recesses 36 and 38 of the seat component 10 by means of the latching means 16, 18, which are formed by barb-shaped latching arms, while the fastening means 14, in the fitted state, is fastened by means of the latching means 20, 22 to corresponding components 50 and 52 formed by a supporting tube (FIGS. 1, 2 and 4 to 6). The latching means 20, 22 are formed by latching arms which form a C-shaped receiving region for the supporting tube.

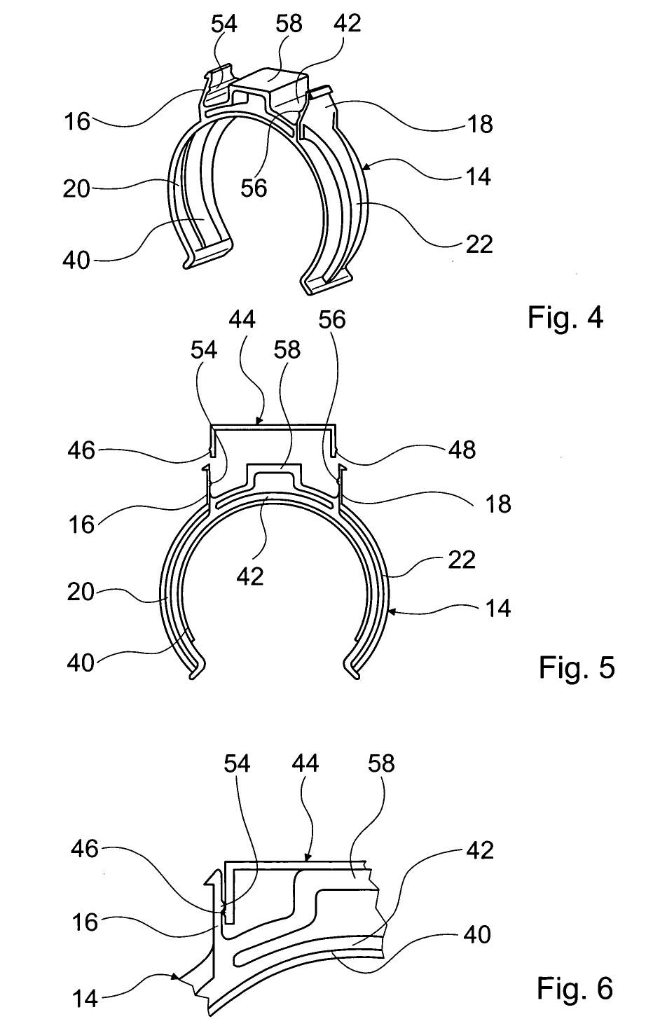

The fastening means 14 is produced in a two-component injection molding process, to be precise the fastening means 14 has a basic body 42 composed of a first plastic and a means 40, or friction device, which is integrally formed by the two-component injection molding process on an inner side of the latching arms forming the latching means 20, 22 and is composed of a second, rubber-like plastic which has a higher coefficient of friction with respect to the supporting tubes than the basic body 42 of the fastening means 14 (FIGS. 4, 5 and 6). By means of the means 40, a particularly secure support, in particular in the longitudinal direction of the supporting tubes, is advantageously achieved.

In principle, two fastening means 14 in the front region of the seat component 10 are latched into the front latching recesses 36 and two fastening means 14 in the rear region of the seat component 10 are latched into the rear latching recesses 38. However, the seat component 10 has more than four latching recesses 36, 38, and therefore also more fastening means 14 can be provided and/or in particular the fastening means 14 can also be arranged at different positions depending on spatial boundary conditions.

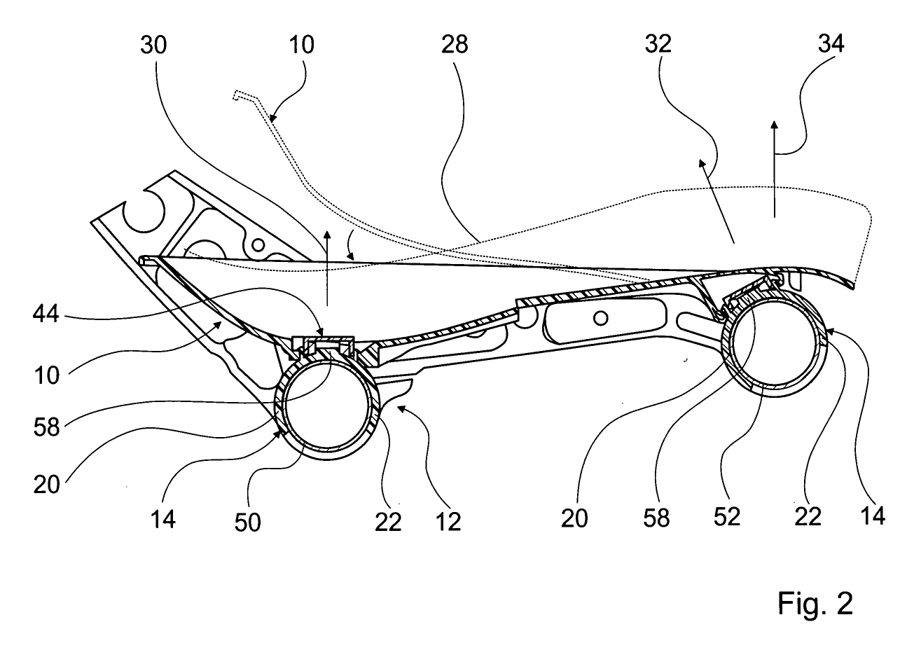

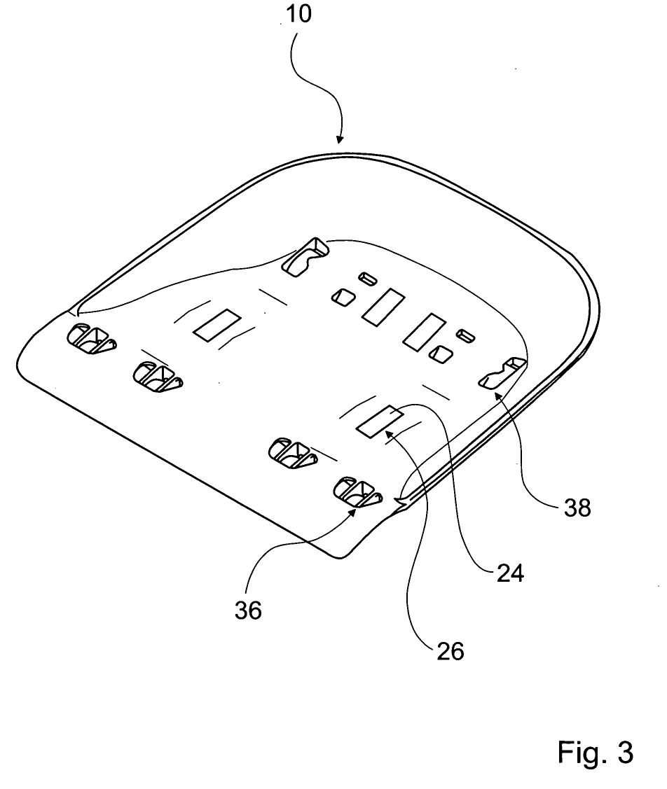

In addition to the fastening unit 12 for fastening the seat component 10 to the supporting tubes, the seating apparatus has a further fastening unit 26 which is provided for fastening an upholstery unit 28 on the seat component 10 (FIGS. 2 and 3). The fastening unit 26 comprises touch-and-close means 24 which are fastened on an upper side of the seat component 10 and interact in the fitted state with touch-and-close means (not illustrated specifically) fastened to the upholstery unit 28. In the fitted state, the fastening unit 12 of the seat component 10 requires a removal force in the main removal directions 30, 32 of the seat component 10 that is approx. 50% greater than a removal force required in a main removal direction 34 of the fastening unit 26 of the upholstery unit 28, in which direction, as experience has shown, the upholstery unit 28 is generally removed from the seat component 10. As a result, the main removal directions 30, 32 of the seat component 10 arise in the direction in which the latching means 20, 22 are substantially uniformly deflected during removal and therefore in the direction in which the fastening means 14 can be decoupled from the supporting tubes with as small a force as possible.

Furthermore, the invention is based on the finding that the upholstery unit 28 is basically pulled off in the front region of the seat component 10. On the basis thereof, the seat component 10 is configured in the front region in such a manner that, in the fitted state, the front fastening means 14 have a main removal direction 32 which encloses an angle not equal to zero, preferably greater than 5° and particularly preferably greater than 10°, to the main removal direction 34 of the upholstery unit 28 (FIG. 2).

In the fitted state, the front and the rear fastening means 14 have differing main removal directions 30, 32 or main removal directions 30, 32 which enclose an angle not equal to zero, thereby resulting in fitting and, in particular, in removal which are composed of a plurality of differing fitting and removal movements.

For the fitting, first of all the fastening means 14 are introduced with their latching means 16, 18 into the latching recesses 36, 38, the latching means 16, 18 being elastically deflected toward each other and subsequently latching behind edges of the latching recesses 36 and 38. Between the latching means 16, 18, the fastening means 14 has an extension 58 which, in the fitted state, reaches between wall parts of the seat component 10 and serves to support bearing forces.

Subsequently, the latching means 16, 18 are secured in their latching positions by means of a securing means 44, or retainer, formed by a U-shaped clamp, as indicated in the rear region in FIG. 2. For this purpose, the securing means 44 are introduced by their limbs from a side which faces away from the latching means 20, 22 or from a top side of the seat component 10 between the latching means 16, 18 (FIGS. 5 and 6). In order to secure the securing means 44 captively between the latching means 16, 18, said securing means has, on outer sides of its limbs, latching means 46, 48 which are formed by extensions and, when the securing means 44 is introduced between the latching means 16, 18, interact with latching means 54, 56, which are integrally formed on inner sides of the latching means 16, 18 and are formed by extensions, and latch behind said latching means 54, 56.

Subsequently, the seat component 10, substantially oriented horizontally such that the main removal direction 32 which has a fixed orientation relative to the seat component 10 is already substantially aligned vertically, is pressed by the front fastening means 14 substantially in the vertical direction onto the front supporting tube, with the latching means 20, 22 being deflected elastically radially outward and subsequently latching by means of a respective subsection, starting from the seat component 10 in the direction of the front supporting tube, behind the same.

The seat component 10 is subsequently pivoted about the front supporting tube by the rear fastening means 14 in the direction of the rear supporting tube. The rear fastening means 14 are pressed onto the rear supporting tube, with the latching means 20, 22 being deflected elastically radially outward and subsequently being latched, by means of a respective subsection, starting from the seat component 10 in the direction of the rear supporting tube, behind the same. Removal takes place in a reverse sequence. When the fastening means 14 are removed from the seat component 10, the latching means 16, 18 are deflected elastically toward each other by hand.

### REFERENCE NUMBERS

10 Seat component
12 Fastening unit
14 Fastening means
16 Latching means
18 Latching means
20 Latching means
22 Latching means
24 Touch-and-close means
26 Fastening unit
28 Upholstery unit
30 Main removal direction
32 Main removal direction
34 Main removal direction
36 Latching recess
38 Latching recess
40 Means
42 Basic body
44 Securing means
46 Latching means
48 Latching means
50 Corresponding component
52 Corresponding component
54 Latching means
56 Latching means
58 Extension

1-17. (canceled)

18. An aircraft seating apparatus comprising:
at least one seat component being formed as a seat base for supporting an upholstery unit and
a component fastening unit for fastening the seat component to a corresponding component, wherein the component fastening unit has at least one fastener with at least one latch.

19. The seating apparatus as claimed in claim 18, wherein, in a fastened state, the fastener is fastened to the seat component by the latch.

20. The seating apparatus as claimed in claim 18, wherein the at least one latch produces a latching connection between the fastener and the corresponding component.

21. The seating apparatus according to claim 18, wherein the fastener is at least partially made of plastic.

22. The seating apparatus according to claim 18, wherein
the seating apparatus includes an upholstery fastening unit for fastening the upholstery unit, and
the component fastening unit of the seat component requires a removal force in at least one main removal direction of the seat component that is at least 20% greater than a required removal force in at least one main removal direction of the upholstery fastening unit of the upholstery unit.

23. The seating apparatus according to claim 18, wherein the component fastening unit includes at least two fasteners which, in a fastened state, have differing main removal directions.

24. The seating apparatus according to claim 18, wherein the component fastening unit includes at least two structurally identical fasteners.

25. The seating apparatus according to claim 18, wherein the fastener includes at least two latching arms forming a C-shaped receiving region.

26. The seating apparatus according to claim 18, wherein the fastener includes at least one barb-shaped latching arm.

27. The seating apparatus according to claim 18, wherein the seat component includes at least one latching recess.

28. The seating apparatus according to claim 18, wherein at least one friction device, which, in the fitted state, is arranged on the fastener and has a higher coefficient of friction than a basic body of the fastener.

29. The seating apparatus according to claim 18, wherein the seating apparatus includes at least one retainer, which retains the latch in a latched position.

30. The seating apparatus as claimed in claim 29, wherein the retainer has at least one retainer latch.

31. The seating apparatus according to claim 18, wherein the seating apparatus is included in an aircraft seat.

32. The seating apparatus according to claim 18, wherein in a fastened state, the seat component is fastened to the corresponding component being formed as a supporting tube.
